(19) United States
(12) Patent Application Publication
(10) Pub. No.: US 2005/0159268 A1
(43) Pub. Date: Jul. 21, 2005

(54) Power transmission apparatus

(76) Inventor: Jason Yan, Tu-Cheng City (TW)

Correspondence Address: Ladas & Parry, Suite 2100, 5670 Wilshire Boulevard, Los Angeles, CA, 90036-5679, US

(21) Appl. No.: 11/007,943

(22) Filed: Dec. 8, 2004

(30) Foreign Application Priority Data
Jan. 16, 2004 (TW) 093200859

(51) Int. Cl. F16H 48/06

(52) U.S. Cl. 475/343

(57) ABSTRACT

A power transmission apparatus adapted to be coupled to a power system having a drive shaft and adapted to drive a driven element is disclosed. The power transmission apparatus includes: a worm adapted to be coupled to and to be driven by the drive shaft of the power system, the worm being rotatable about a first axis parallel to the drive shaft of the power system; a planetary gear module that engages and that is driven by the worm, the planetary gear module being rotatable about a second axis perpendicular to the first axis; and an output component coupled to the planetary gear module and adapted to be coupled to the driven element, the output component being driven by the planetary gear module for driving movement of the driven element.

### CROSS-REFERENCE TO RELATED APPLICATION

This application claims priority of Taiwanese application No. 093200859, filed on Jan. 16, 2004.

### BACKGROUND OF THE INVENTION

1. Field of the Invention

This invention relates to a power transmission apparatus, more particularly to a power transmission apparatus that includes a worm and a planetary gear module.

2. Description of the Related Art

A conventional power transmission apparatus, such as that used in a rear wheel-driving and self-propelled vacuum cleaner, is mounted inside the vacuum cleaner, so as to transmit power from a motor to a rear wheel unit of the vacuum cleaner. As shown in FIG. 1, the conventional power transmission apparatus 9 includes a speed-reducing spur gear module 92 that is driven by the motor 91, and a worm shaft-worm gear module. The speed-reducing spur gear module 92 includes a driving spur gear 921 that is coupled to a drive shaft 911 of the motor 91 such that rotation of the driving spur gear 921 is driven by the motor 91. The speed-reducing spur gear module 92 further includes a driven spur gear 922 that has a larger number of gear teeth as compared to that of the driving spur gear 921 and that engages the driving spur gear 921 such that rotation of the driving spur gear 921 results in corresponding rotation of the driven spur gear 922. The worm shaft-worm gear module includes a worm shaft that is coupled to the driven spur gear 922 such that the driven spur gear 922 and the worm shaft rotate concurrently about a central axis (X) of the driven spur gear 922 parallel to the drive shaft 911 of the motor 91. The worm shaft-worm gear module further includes a worm gear 94 that engages and that is driven rotatably by a worm 93 formed on the worm shaft. An output shaft 95 is provided for coupling the worm gear 94 to the rear wheel unit of the self-propelled vacuum cleaner (not shown), so as to drive movement of the rear wheel unit through the rotation of the worm gear 94.

The abovementioned conventional power transmission apparatus utilizes the driving spur gear 921 to transmit the power from the motor 91 to the driven spur gear 922, so as to drive directly the driven spur gear 922 that has a larger number of gear teeth as compared to that of the driving spur gear 921. Since the speed-reducing ratio of the driving spur gear 921 to the driven spur gear 922 is high, and since the engagement and power transmission between the driving and driven spur gears 921, 922 are conducted through a striking action, the power cannot be evenly transmitted at any time and generation of noise cannot be reduced or avoided.

### SUMMARY OF THE INVENTION

Therefore, the object of the present invention is to provide a power transmission apparatus that can eliminate the aforesaid drawbacks of the prior art.

According to this invention, there is provided a power transmission apparatus adapted to be coupled to a power system having a drive shaft and adapted to drive a driven element. The power transmission apparatus includes: a worm adapted to be coupled to and to be driven by the drive shaft of the power system, the worm being rotatable about a first axis parallel to the drive shaft of the power system; a planetary gear module that engages and that is driven by the worm, the planetary gear module being rotatable about a second axis perpendicular to the first axis; and an output component coupled to the planetary gear module and adapted to be coupled to the driven element, the output component being driven by the planetary gear module for driving movement of the driven element.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view to illustrate a conventional power transmission apparatus including a speed-reducing spur gear module coupled to a worm shaft-worm gear module;

FIGS. 2 and 3 are perspective partly exploded views of the preferred embodiment of a power transmission apparatus according to this invention that is coupled to a power system and a driven element;

FIG. 4 is a perspective view to illustrate a sun gear unit of a planetary gear module included in the preferred embodiment;

FIG. 5 is a fragmentary exploded perspective view to illustrate how the planetary gear module is coupled to an output component and is further coupled to the power system through a worm in the preferred embodiment;

FIG. 6 is a perspective view to illustrate the output component employed in the preferred embodiment; and

FIG. 7 is a schematic view to illustrate how a sun gear unit engages and drives a planet gear unit in the planetary gear module used in the preferred embodiment.

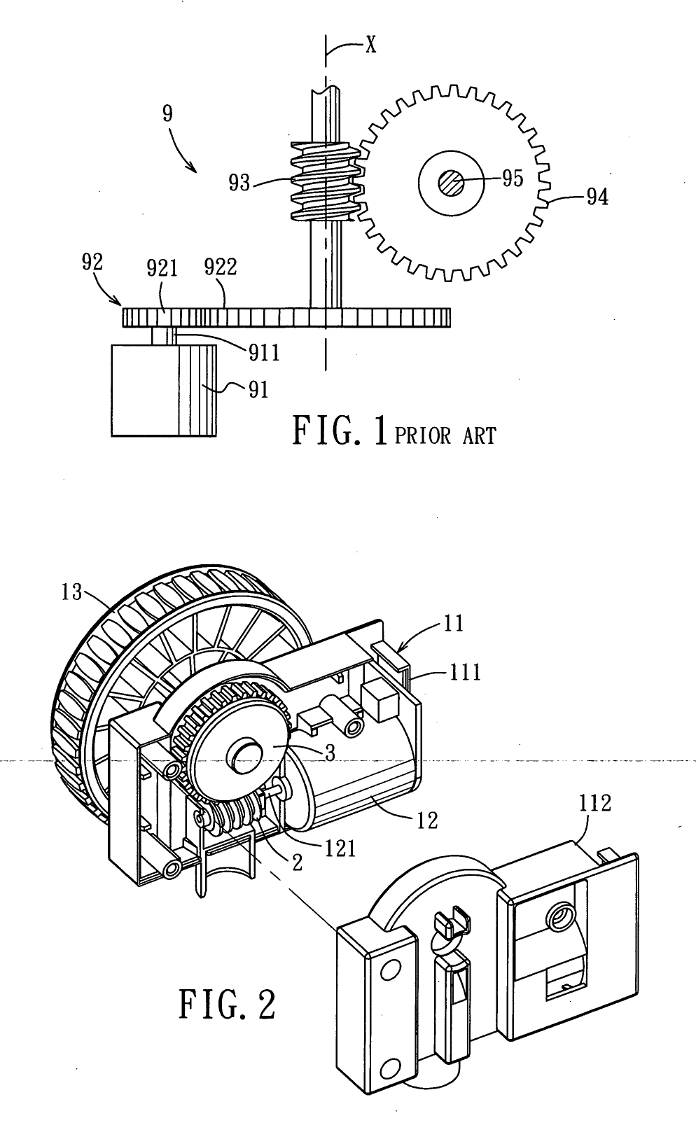

### DETAILED DESCRIPTION OF THE PREFERRED EMBODIMENTS

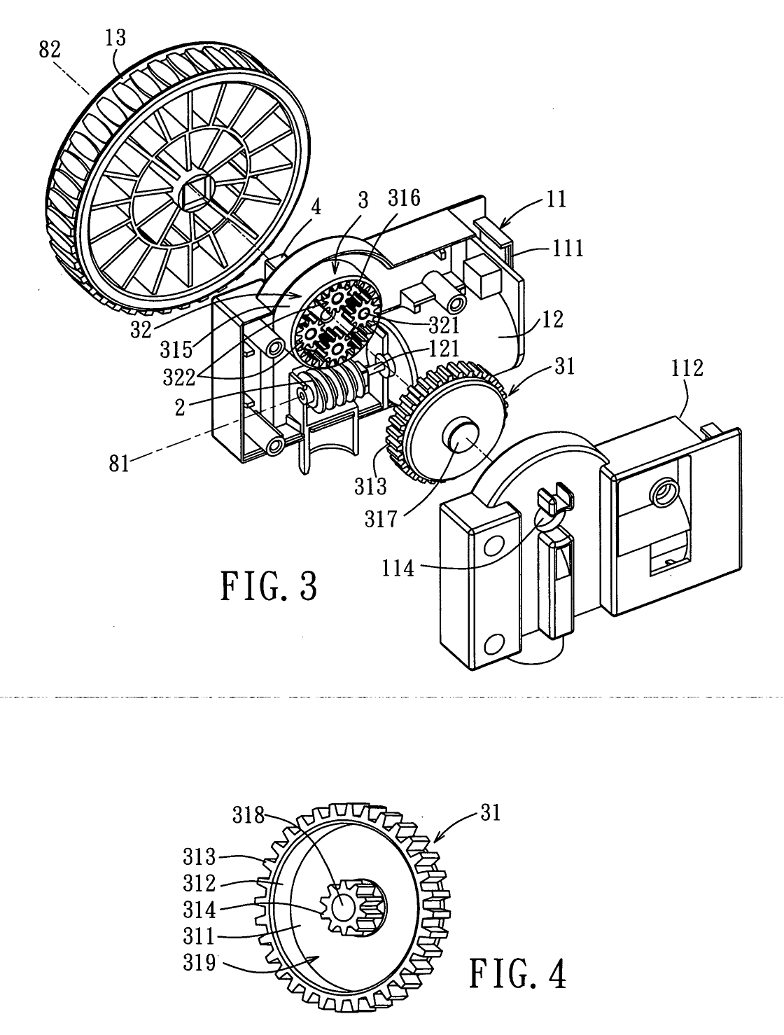

Referring to FIGS. 2 and 3, the preferred embodiment of a power transmission apparatus according to this invention is adapted to be coupled to a power system 12 having a drive shaft 121, such as a motor, and is adapted to drive a driven element 13, such as a wheel unit of a rear wheel-driving and self-propelled vacuum cleaner (not shown). Alternatively, the driven element may be a toy vehicle or a machine tool.

In this embodiment, the power system 12 is a motor, and the driven element 13 is a left rear wheel of a rear wheel-driving and self-propelled vacuum cleaner. The power transmission apparatus of this invention is coupled to the left rear wheel 13 of the vacuum cleaner, is adapted to be mounted to a main body of the vacuum cleaner, and enables forward movement of the vacuum cleaner.

The power transmission apparatus of this invention includes a base body 11 that is composed of a left housing 111 and a right housing 112 so as to define a chamber therebetween, a worm 2 and a planetary gear module 3 that are both disposed in the chamber, and an output component 4 adjacent to the left housing 111 and disposed outwardly of the chamber.

The worm 2 is adapted to be coupled to and to be driven by the drive shaft 121 of the motor 12 that is likewise disposed in the chamber, and is rotatable about a first axis 81 parallel to the drive shaft 121 of the motor 12. The planetary gear module 3 engages and is driven by the worm 2, and is rotatable about a second axis 82 perpendicular to the first axis 81. The output component 4 is coupled to the planetary gear module 3, is adapted to be coupled to the left rear wheel 13 of the vacuum cleaner, and is driven by the planetary gear module 3 for driving movement of the left rear wheel 13 of the vacuum cleaner.

Preferably, the planetary gear module 3 has a bearing portion 317, and the right housing 112 of the base body 11 has a bearing hole 114 extending along the second axis 82. The bearing portion 317 of the planetary gear module 3 extends into the bearing hole 114 when the planetary gear module 3 is mounted in the chamber.

Referring to FIGS. 3 and 4, the planetary gear module 3 includes a sun gear unit 31 having a base wall 311, an annular surrounding wall 312 that extends from the base wall 311 and that cooperates with the base wall 311 to define a chamber 319, and that has inner and outer wall surfaces, and outer gear teeth 313 that are formed on the outer wall surface of the annular surrounding wall 312, and that engages the worm 2 such that rotation of the worm 2 about the first axis 81 results in corresponding rotation of the sun gear unit 31 about the second axis 82.

The sun gear unit 31 further has a sun gear 314 that is disposed in the chamber 319 on the base wall 311 and that is rotatable together with the base wall 311 and the annular surrounding wall 312 about the second axis 82.

As shown in FIGS. 3, 5 and 7, the planetary gear module 3 further includes a planet gear unit 32 having a ring body 315 fitted in the chamber 319 of the sun gear unit 31 and having an outer ring surface that abuts against the inner wall surface of the annular surrounding wall 312. The ring body 315 further has an inner ring surface. Inner gear teeth 316 are formed on the inner ring surface of the ring body 315. In addition, a plurality of planet gears 322 are disposed in the chamber 319 of the sun gear unit 31 between the ring body 315 and the sun gear 314. The planet gears 322 are disposed around the sun gear 314, mesh with the inner gear teeth 316 and the sun gear 314, and are coupled to the output component 4.

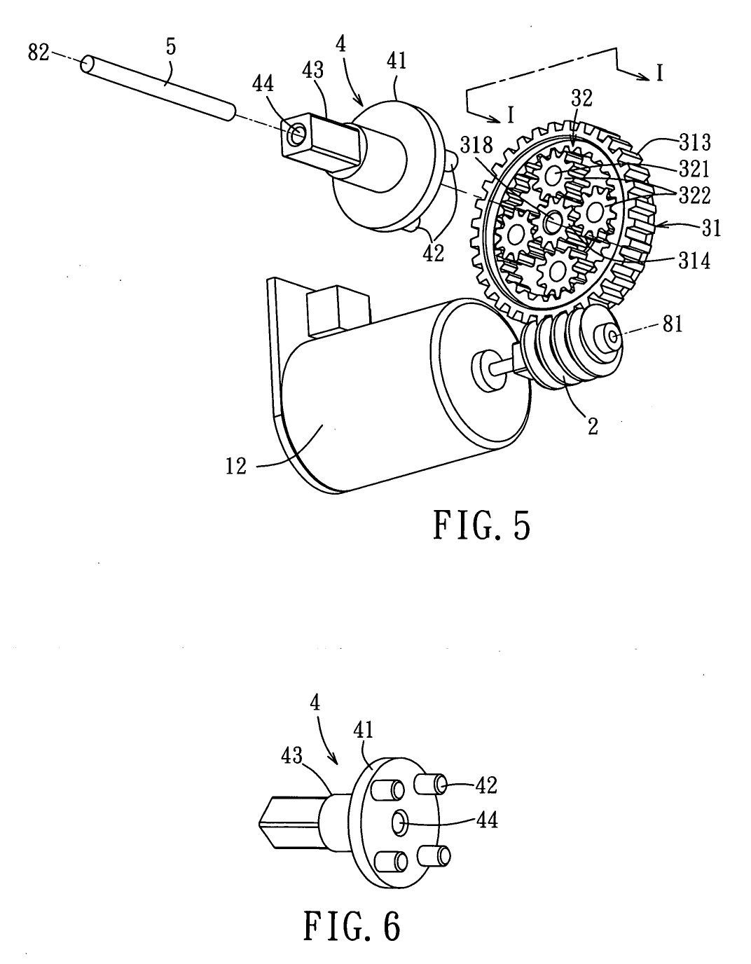

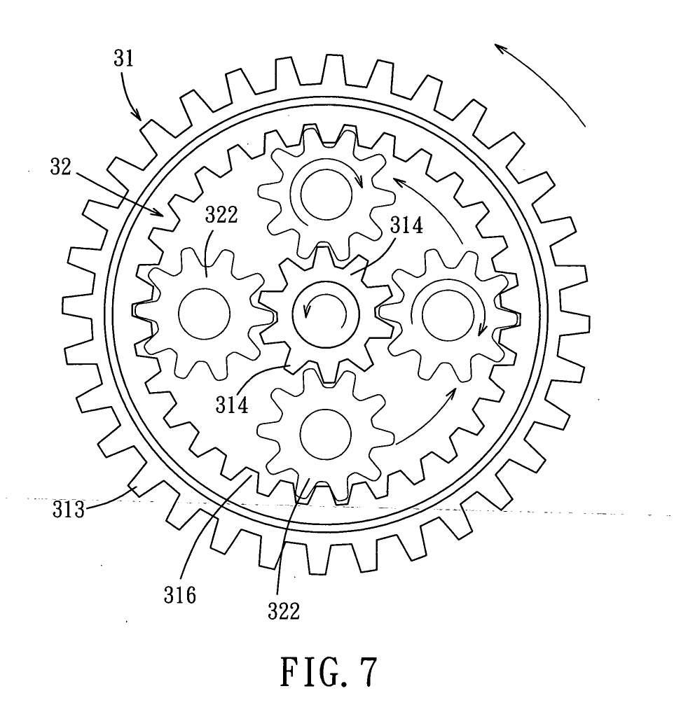

Referring to FIGS. 5 and 6, each of the planet gears 322 is formed with an axle hole 321 that extends parallel to the second axis 82. The output component 4 includes a base part 41 with opposite first and second connecting sides. The first connecting side is formed with a plurality of axles 42, each of which engages the axle hole 321 in a respective one of the planet gears 322. The second connecting side of the output component 4 is adapted to be coupled to the left rear wheel 13 of the vacuum cleaner. Preferably, the second connecting side of the output component 4 is formed with a coupling shaft 43 adapted for coupling with the left rear wheel 13 of the vacuum cleaner.

As shown in FIGS. 4 and 5, preferably, the sun gear 31 is formed with a first rod hole 318, and the output component 4 is formed with a second rod hole 44. Each of the first and second rod holes 318, 44 extends along the second axis 82. The power transmission apparatus further includes a rod 5 that extends into the first and second rod holes 318, 44.

Referring to FIGS. 3, 5 and 7, concerning the power transmission mechanism of the power transmission apparatus of this invention, the motor 12 is activated by a power supply (not shown) and drives the drive shaft 121 so as to drive the worm 2 to rotate about the first axis 81. The rotation of the worm 2 about the first axis 81 results in corresponding counterclockwise rotation of the sun gear unit 31 about the second axis 82 through meshing of the worm 2 with the outer gear teeth 313. Synchronously, the planet gears 322 rotate clockwise about the respective axle 42 the second axis 82 through meshing with the sun gear 314 and revolve counterclockwise around the sun gear 314 through meshing with the inner gear teeth 316. In the meantime, the output component 4 is driven by the planetary gear module 3 through the axles 42 that extend into the axle holes 321 of the planet gears 322, and drives the left rear wheel 13 of the vacuum cleaner to rotate about the second axis 82.

According to the power transmission apparatus of this invention, the power from the motor 12 can be transmitted with reduced speed and evenly to the outer gear teeth 313 and with low friction. Although both the sun gear 314 and the planet gears 322 driven thereby have a spur gear structure, noise attributed to meshing of the sun gear 314 with the planet gears 322 can be eliminated due to considerable reduction in the speed of of the sun gear 314. In addition, the power transmission apparatus of this invention can be implemented through utilization of one planetary gear module 3 having four planet gears 3-22. Such a simple configuration not only reduces wear due to friction but also saves maintenance costs.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A power transmission apparatus adapted to be coupled to a power system having a drive shaft and adapted to drive a driven element, said power transmission apparatus comprising:
a worm adapted to be coupled to and to be driven by the drive shaft of the power system, said worm being rotatable about a first axis parallel to the drive shaft of the power system;
a planetary gear module that engages and that is driven by said worm, said planetary gear module being rotatable about a second axis perpendicular to the first axis; and
an output component coupled to said planetary gear module and adapted to be coupled to the driven element, said output component being driven by said planetary gear module for driving movement of the driven element.

2. The power transmission apparatus as claimed in claim 1, wherein said planetary gear module includes a sun gear unit having
a base wall,
an annular surrounding wall extending from said base wall and cooperating with said base wall to define a chamber, said annular surrounding wall having inner and outer wall surfaces, and
outer gear teeth formed on said outer wall surface of said annular surrounding wall, said outer gear teeth engaging said worm such that rotation of said worm about the first axis results in corresponding rotation of said sun gear unit about the second axis.

3. The power transmission apparatus as claimed in claim 2, wherein said sun gear unit further has a sun gear that is disposed in said chamber on said base wall and that is rotatable together with said base wall and said annular surrounding wall about the second axis.

4. The power transmission apparatus as claimed in claim 3, wherein said planetary gear module further includes a planet gear unit having
a ring body fitted in said chamber of said sun gear unit and having an outer ring surface that abuts against said inner wall surface of said annular surrounding wall, said ring body further having an inner ring surface,
inner gear teeth formed on said inner ring surface of said ring body, and
a plurality of planet gears disposed in said chamber of said sun gear unit between said ring body and said sun gear, said planet gears being disposed around said sun gear, meshing with said inner gear teeth and said sun gear, and being coupled to said output component.

5. The power transmission apparatus as claimed in claim 4, wherein each of said planet gears is formed with an axle hole that extends parallel to the second axis, said output component including a base part with opposite first and second connecting sides, said first connecting side being formed with a plurality of axles, each of which engages said axle hole in a respective one of said planet gears, said second connecting side of said output component being adapted to be coupled to the driven element.

6. The power transmission apparatus as claimed in claim 5, wherein said second connecting side of said output component is formed with a coupling shaft adapted for coupling with the driven element.

7. The power transmission apparatus as claimed in claim 5, wherein said sun gear is formed with a first rod hole, said output component being formed with a second rod hole, each of said first and second rod holes extending along the second axis, said power transmission apparatus further comprising a rod that extends into said first and second rod holes.
